(19) United States
(12) Patent Application Publication
(10) Pub. No.: US 2005/0179962 A1
(43) Pub. Date: Aug. 18, 2005

(54) Compact optical scanhead

(76) Inventor: James B. Williamson, Sunnyvale, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/778,631

(22) Filed: Feb. 13, 2004

(51) Int. Cl. H04N 1/40

(52) U.S. Cl. 358/473; 358/471

(57) ABSTRACT

An optical scanhead uses anamorphic optics and/or grazing incidence waveguides.

### BACKGROUND OF THE INVENTION

1. Field of the Invention

This invention relates generally to an optical scanhead, such as used in electronic scanners. More particularly, the invention relates to an optical scanhead using grazing incidence waveguides and/or anamorphic optics.

2. Description of the Related Art

Devices that can scan a document and convert it to an electronic format are used in a number of applications. For example, photocopiers, fax machines and document scanners (including for example flatbed, rotary, and handheld) are just a few examples. In a typical design, an optical scanhead images a document (or a portion of the document) as the scanhead is scanned across the document.

One common scanhead technology for document scanners is the reduction optics system, as shown in side cross section in FIG. 1. In this system, an object to be scanned 2 is placed upon a 3 mm thick transparent platen 4. The object 2 is illuminated by incident light 8 from light source 6, typically a cold cathode fluorescent lamp. The reflected light 9 from a scanline 10 (extending perpendicular to the paper in this view) on the document 2 subtends a total collection angle 40. This angle is usually around 1 degree, or 0.5 half angle, and is set by the desired depth of field at the document. Reflected light 9 is relayed by mirrors 12 to a symmetric conic reduction lens 14 where it is imaged onto the plane of a photosensitive image sensor 16. The image sensor 16 sits on printed circuit board 18 with other associated control electronics. The image sensor 16 converts the light from the document 2 into an electronic signal, which is relayed to an external control system, typically a processor, via cable 19.

In the conventional reduction system, the image sensor 16 typically has three rows of detectors, each detecting the image of a single separate, but adjacent, scanline 10 from the document. Only one scanline 10 is shown in FIG. 1 for clarity. The scanline 10 is a line that is perpendicular to the plane of FIG. 1 and located at the top of the platen 4. The direction of the scanline will be referred to as the “x” direction. In document scanners, the length of the scanline 10 is typically set to fit “A” size paper and is 8.5″ or 216 mm. Each of the sensor rows has a filter over the individual detector elements that either allows red, green, or blue (heretofore r, g, b) light through to the detector, as further described in Gann, Robert G., Desktop Scanners: Image Quality Evaluation, Prentice Hall, 1998, ISBN 0-13-080904-7 (hereafter, “Gann 1998”).

The scanhead steps the distance of a single scanline at a time by a motor and pulley system (not shown) in the scan direction (the “z” direction). At each step, another “picture” of the three scanlines imaged onto the three sensor rows is taken and sent to the computer. A final image of each sampled line is created by adding up the individual r, g, and b information for that line and an entire image is formed from each of the successive scanlines. Note the diameter 22 and length 20 of the reduction lens 14 are typically approximately 0.5″ and approximately 0.5-1″, respectively. The height 24 and width 26 of the reduction optics scan module are approximately 1.5″ and 3.2″, respectively. The overall height 24 of the scan module is limited by the maximum “height” 52 of the beam and the total optical path length from the document to the lens 14. The scan module for A4 documents is typically approximately 9 inches in depth (i.e., along the x direction), for a total size of approximately 1.5″×3.2″×9″. The reduction optics system typically has an f-number of approximately 5 to 10 (i.e., low numerical aperture) and an associated high depth of field. A high depth of field is desirable for scanning materials that do not perfectly sit at the top of platen 4, such as the inner binding crease of a book or other three-dimensional objects.

This approach has many drawbacks. For example, one drawback of this system is the large size of the folded optics. This adds size and, therefore, cost to the overall system price. Second, the technique of reassembling successive addition of scanlines of different colors taken at different times is subject to positional error in the translation of the scanhead. Third, at the extremes at the end of the scanline, the optical intensity is decreased due to the reduction in apparent size of the collecting lens aperture. As a final example, the image position above the platen changes at high capture angles and causes image distortion.

Another common scanhead technology is the contact image sensor (CIS), as shown in side cross section in FIG. 2. As with the reduction system, a light source 6, typically an r, g, b LED array in CIS systems, illuminates with incident light 8 the document 2 sitting on transparent platen 4. Reflected light 9 from scanline 10 on the document 2 is imaged by the rod lens array 29 onto the CIS image sensor 28. Unlike typical reduction optics systems, the CIS scanhead steps a single scanline and the r, g, and b led arrays light sequentially. A full color r, g, and b image is formed at each scanline step. Again, the signal from the detector array is sent via a cable to an external computer (not shown). CIS systems are generally much smaller than the reduction optics systems; CIS module height 30 and width 32 are typically, 0.5″ and 0.75″ respectively. The module is again approximately 9″ in length when configured to scan A4 size documents.

The CIS system also has significant drawbacks. For example, the GRIN rod lens arrays used for this system typically have a low f-number and have relatively poor depth of field of approximately 1 mm or less. Second, the large area detectors used with CIS image sensor 28 have increased noise and worse signal-to-noise ratios than the small detector elements used in the reduction system.

Thus, there is a need for an optical scanhead that address the problems of bulkiness, cost, and optical fidelity existing in current optical scanheads.

### SUMMARY OF THE INVENTION

The present invention overcomes the limitations of the prior art by utilizing anamorphic optics and/or grazing incidence waveguides in optical scanheads.

In one aspect of the invention, anamorphic optics allows the optical scanhead to be optimized separately for the two orthogonal directions. In one embodiment, assume that the scanline to be imaged extends along an x direction. The optical scanhead includes a y-z plane imaging system and an x-y plane imaging system that image the scanline in a y-z plane and x-y plane, respectively. Both imaging systems have optical axes that extend along the y direction, but the y-z plane imaging system images differently than the x-y plane imaging system. In some applications, the y-z plane imaging system can have a different numerical aperture, field angle and/or depth of field than the x-y plane imaging system.

The imaging systems can be implemented in various ways. For example, cylindrical optics can be used to implement some or all of the optical elements with power. In one particular design, the y-z plane imaging system includes a first imaging system for imaging the scanline to an intermediate image and an image sensor focusing system for relaying the intermediate image to an image sensor. Additional relays may be used to relay the images from the first imaging system to the image sensor focusing system. Additionally, the x-y plane imaging system may include a second imaging system located between the first imaging system and the image sensor focusing system, for imaging the scanline in the x-y plane to the image sensor. Example designs include the achromatic doublet for the y-z plane imaging system and the triplet, Tessar and double Gauss for the x-y plane imaging system.

In an alternate design, the y-z plane imaging system includes a first imaging system for imaging the scanline in the y-z plane to near infinity. In another alternate design, the x-y plane imaging system is a telecentric imaging system. The different designs may also be arrayed, either in the x direction and/or in the z direction. The optical axis may also be folded, for example into a “z” shape.

In another aspect of the invention, the optical scanhead includes an x-y plane imaging system and a y-z plane imaging system, and the y-z plane imaging system includes a grazing incidence waveguide. The anamorphic designs described above can be adapted for use with the grazing incidence waveguide. In different embodiments, the optical elements, including both those with and without power, can be located either internal or external to the grazing incidence waveguide. In certain waveguide designs, some of the optical elements can be eliminated.

In one approach, the grazing incidence waveguide is implemented as a stacked waveguide. The stack includes a plurality of waveguides stacked in the z direction and beam turning elements for directing light from one waveguide in the stack to a next waveguide in the stack. Different designs are possible for both the waveguides and the beam turning elements. For example, the beam turning elements can be located internal or external to the waveguides. They may or may not be integrated with the waveguides. They may or may not have optical power. The stack can be designed to be constructed from a plurality of similarly shaped guide structures. One advantage of grazing incidence waveguides is that they can be made short, for example 100 um. A stack of three waveguides could have a total height of 700 um or less.

Other aspects of the invention include methods corresponding to the devices described above and applications for these devices.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 (prior art) is a side cross sectional view of a reduction optics scanhead.

FIG. 2 (prior art) is a side cross sectional view of a contact image sensor scanhead.

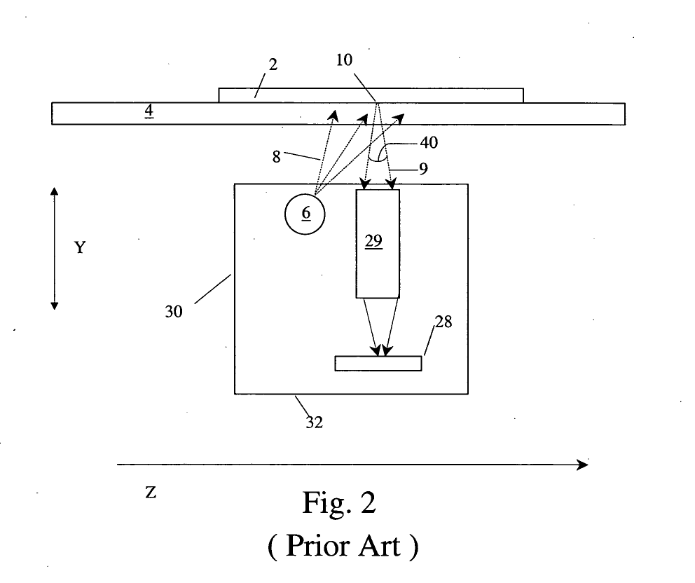

FIG. 3 is a side cross-sectional view of an unfolded split lens anamorphic scanhead.

FIG. 4 is a side cross-sectional view of an unfolded relay lens type, split lens anamorphic scanhead.

FIG. 5 is a side cross-sectional view of an unfolded nearly collimated split lens anamorphic scanhead.

FIG. 6 is a side cross-sectional view of a stacked array of the anamorphic scanhead of FIG. 5.

FIG. 7 is a side cross-sectional view of an unfolded split lens anamorphic scanhead using a grazing incidence waveguide.

FIG. 8 is a side cross-sectional view of an unfolded split lens anamorphic scanhead with optical elements placed internal to the grazing incidence waveguide.

FIG. 9 is a side cross-sectional view of an unfolded split lens anamorphic scanhead using a grazing incidence waveguide without a front y-z plane imaging system.

FIG. 10 is a side cross-sectional view of an unfolded split lens anamorphic scanhead using a grazing incidence waveguide without front and rear y-z plane imaging systems.

FIG. 11 is a side cross-sectional view of an unfolded scanhead using a grazing incidence waveguide and a symmetric conic reduction optics lens.

FIG. 12 is a side cross-sectional view of an unfolded scanhead using conventional reduction optics lens inside a grazing incidence waveguide.

FIG. 13 is a top cross-sectional view of an array of the scanheads of FIG. 8.

FIGS. 14a and 14b are a top and side cross-sectional view of an unfolded grazing incidence scanhead using an internal planar telecentric imaging system.

FIG. 15 is a top cross-sectional view of an array of the scanheads of FIG. 14.

FIG. 16 is a side cross-sectional view illustrating optical folding of the anamorphic scanhead of FIG. 5.

FIGS. 17a and 17b are side cross-sectional views of reflective and total internal reflection techniques for optically folding a grazing incidence waveguide.

FIG. 18 is a side cross-sectional view of a reflective method for optically folding a grazing incidence waveguide where the reflector is placed within the guide.

FIG. 19 is a side cross-sectional view of a reflective method for optically folding a grazing incidence waveguide where the reflector is integral to the guide.

FIG. 20 is a side cross-sectional view of the waveguide stack of FIG. 19 using concave reflectors.

FIG. 21 is a side cross-sectional view of a total internal reflection method for optically folding a grazing incidence waveguide where the reflector is integral to the guide.

FIG. 22 is a side cross-sectional view of the waveguide stack of FIG. 21 with the addition of lenses integrated on the reflector input and output faces.

FIG. 23 is a rear cross-sectional view illustrating the sag in a waveguide stack supported only on two edges.

FIG. 24 is a top cross-sectional view of an unfolded waveguide stack and placement of interlayer supports.

FIG. 25 is a rear cross-sectional view of two methods for supporting a waveguide stack.

FIGS. 26a and 26b are side cross-sectional views of cylindrical and planar cylindrical coupling lenses.

FIG. 27 is a side cross-sectional view of a planar GRIN coupling lens.

FIGS. 28a and 28b are side cross-sectional views of a planar diffused lens and an optical system using those lenses.

FIGS. 29a and 29b are a top and side cross-sectional view of a planar triplet lens.

FIGS. 30a-30c are side cross-sectional views of different types of planar apertures.

FIG. 31 is a side cross-sectional view of an optical scanhead based on FIG. 8.

FIG. 32 is a side cross-sectional view of an optical scanhead based on FIG. 7.

FIG. 33 is a side cross-sectional view of an optical scanhead based on FIGS. 6 and 7.

FIG. 34 is a side cross-sectional view of a folded grazing incidence scanhead incorporating dichroic color separation into separate waveguides.

FIG. 35 is a side cross-sectional view of a vertically folded grazing incidence optical scanhead.

FIG. 36 is a side cross-sectional view of a vertically folded grazing incidence optical scanhead incorporated into a handheld document scanner.

FIG. 37 is a perspective view of an optical scanner incorporated into the upper lid of a laptop computer.

FIG. 38 is a front view of an optical scanner incorporated into the bottom of a laptop computer.

### DETAILED DESCRIPTION OF THE PREFERRED EMBODIMENTS

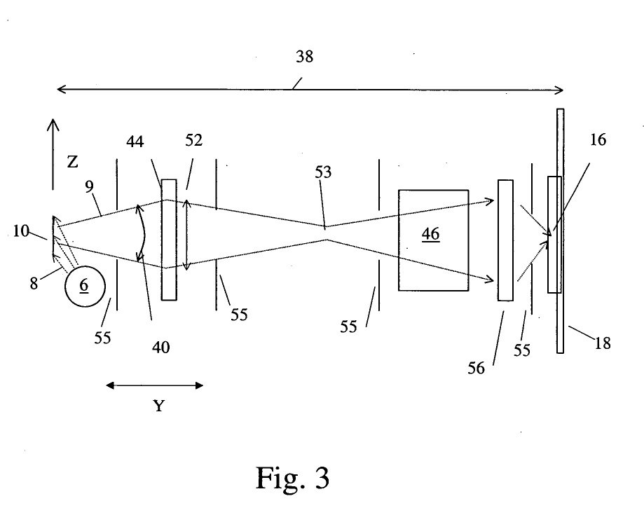

FIGS. 3-16 show various examples of anamorphic and/or grazing incidence optical scanheads according to different aspects of the invention. In these examples, the x direction is the direction parallel to the scanline; the z direction is the orthogonal direction but still in the plane of the object being scanned; and the y direction is the direction perpendicular to the plane of the object. At the object, the optical axis is initially along the y direction but may change directions, for example if the optical system is folded. Many of the optical principles will be illustrated with reference to x, y and z directions in the context of an unfolded system. It is to be understood that these directions may change accordingly for folded systems.

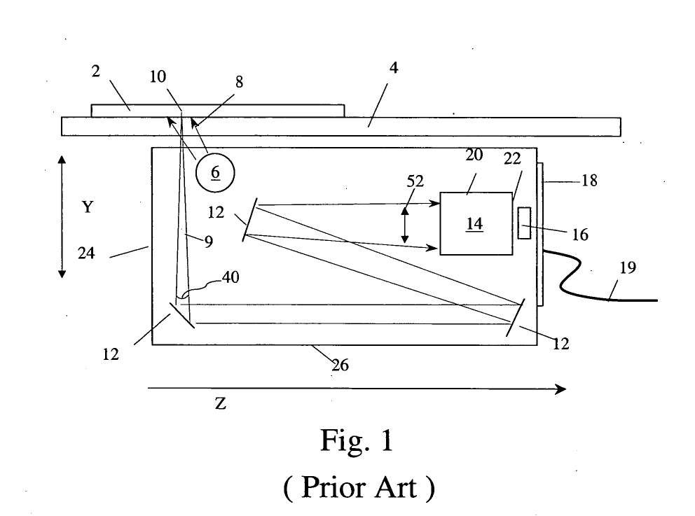

FIG. 3 shows a compact scanhead based on anamorphic optics, where the two orthogonal meridional planes are imaged differently. For clarity, the system in FIG. 3 is not shown folded as is FIG. 1, but this folding of the optical path via mirrors could easily be applied here also. As opposed to the single reduction lens system of FIG. 1, the anamorphic system includes imaging systems 44 and 46. In this case, light emitted from scanline 10 with a ray trajectory in the y-z plane is imaged by y-z plane imaging system 44, whereas light emitted from scanline 10 with a ray trajectory in the x-y plane is imaged by x-y plane imaging system 46. Both of these lens systems can be implemented as cylindrical optical systems since they only image in one plane.

This separation of imaging functions for the two directions creates an advantage for this system over the conventional reduction optics lens system since the y-z plane imaging system can be designed to image differently than the x-y plane imaging system. The imaging functions can be optimized independently. For example, the requirements for a lens system imaging the document in the y-z plane typically are a low numerical aperture and field angle. This regime of imaging is well satisfied by achromatic doublets. In the x-y plane, along the scanline, imaging of the high field angle is best served by triplets, Tessars, and double Gauss systems. These separate requirements cannot be simultaneously optimized by a conventional system where there is the same conic for each lens face.

However, this does not imply that only cylindrical surfaces can be used. In some designs, it will be true that all optical elements in the optical scanhead that have optical power will only have power in either the x-y plane or in the y-z plane, but not both. However, in some designs, some of the optical elements can have power in both the x-y plane and in the y-z plane. Recall that, to a first approximation, two crossed cylindrical lenses are equivalent to a spherical lens.

In FIG. 3, the y-z plane imaging system 44 forms an intermediate image 53, somewhere between the two imaging systems 44 and 46 depending upon the desired magnification ratios, which is then imaged by y-z plane image sensor focusing system 56 onto the image sensor 16, here a three line linear detector array. A series of y-z plane absorbing apertures 55 can be used to eliminate stray light. The y-z plane image sensor focusing system 56 focuses the intermediate image 53 to the image sensor 16. The overall y-z plane optical system that relays reflected light from the scanline 10 onto the image sensor 16 includes both the y-z plane imaging system 44 and the y-z plane image sensor focusing system 56. Again, folding can be done in the same manner as the conventional reduction system. However, a more compact system with a smaller height can be created since the sum of beam heights for a folded version of this system is smaller than the sum of beam heights in the reduction system. This is because the anamorphic approach allows the beam heights 52 to be reduced (while still allowing large field of view in the orthogonal direction) since the two directions are imaged differently. Examples of different folded systems are discussed further below.

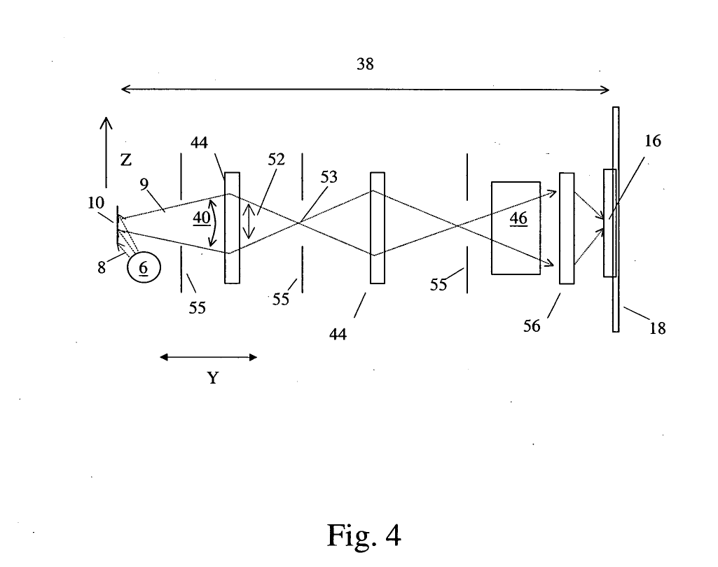

FIG. 4 is an extension of FIG. 3 and uses multiple lenses 44 to relay the light in the y-z plane. This system has the advantage of more degrees of freedom in moving the captured light from the page to the detectors. For example, the first y-z plane imaging system 44 could be used to form a reduced image. Subsequent lenses can then relay that smaller image to the image sensor 16. As in FIG. 3, x-y plane imaging system 46 operates to image in the x-y plane.

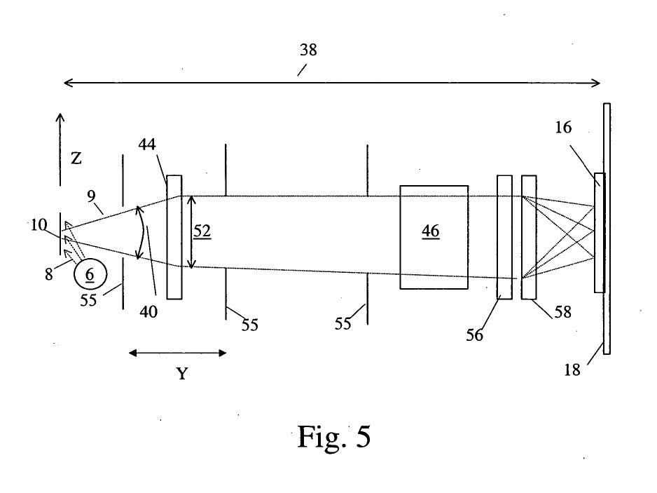

FIG. 5 is another extension of FIG. 3. In this example, the y-z plane imaging system 44 is designed to image the scanline to near infinity. A nearly collimated beam is created and this images a much narrower region of the document. Since only approximately a single scanline is imaged, some form of color separation optics is used in the optical path if color is desired. This color separation optical system 58 is shown schematically as a transmissive system in FIG. 5. However, there are a number of existing techniques, both transmissive and reflective, for accomplishing this. Gann 1998 describes a number of these techniques, which are incorporated by reference herein. Additionally, instead of color separation, a three pass or three color exposure system can be used. A reflective or transmissive Dammann grating can also be used to split the light into three colors, as described in U.S. Pat. No. 4,227,138 by Dammann and U.S. Pat. No. 5,223,703 by Setani, the teachings of both of which are incorporated by reference herein. The Dammann grating, and other binary optical devices, may be integrated on the front lens surface of y-z plane image sensor focusing system 56 in order to eliminate a separate component. In another approach, a stacked detector (i.e., red, green and blue detectors which are stacked on top of each other) may be used. Detectors of this type are available from Foveon and described in U.S. Pat. No. 6,632,701, which is incorporated by reference herein.

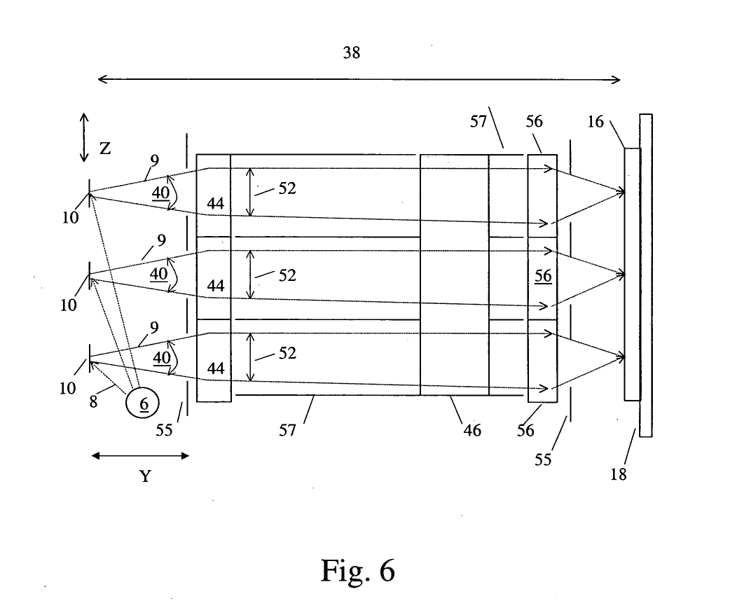

The system of FIG. 6 is similar to FIG. 5 except that the nearly collimated system in FIG. 5 is replicated to form a vertically stacked array. Each collimated system is responsible for detecting red, blue, or green bands from the document. Color separation is performed in the conventional manner as with the standard reduction system, using a separate detector array with red, blue, or green color filters. Alternatively, a two-dimensional area array detector with bands of color filters could be used to ease alignment of the optical beams to the detectors. This system can image a larger area at scanline 10 but the subsequent beam angle 40 will decrease limited by the etendue. The upper limit is when the beam from scanline 10 is already collimated and the y-z plane imaging system 44 performs no function. Absorbing baffles 57 can be used to limit stray light.

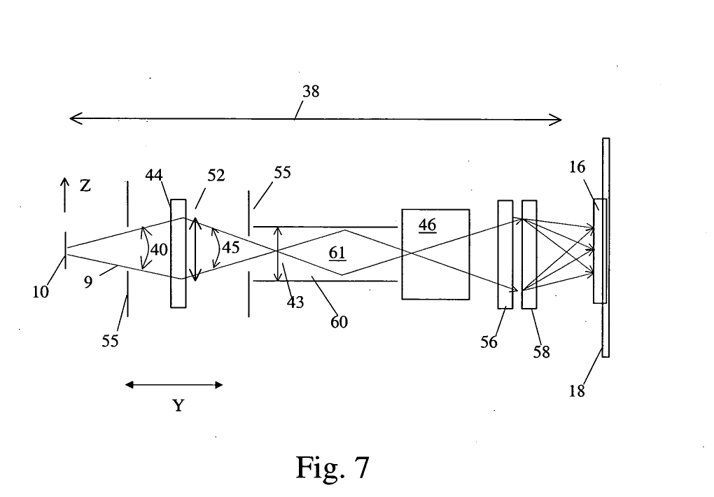

FIG. 7 shows a system using a grazing incidence waveguide. A grazing incidence waveguide includes two grazing incidence waveguide walls 60, which are typically planar parallel reflective dielectric plates. Light with near grazing incidence angles reflects with very little loss. Furthermore, since the guide uses air, there is no significant dispersion as would be true with a solid dielectric waveguide. The guides also act as angular filters. That is, light with angles away from grazing does not propagate well. The guides shown are parallel, but the guides can be tilted relative to each other to affect other properties. For example, if the guides are tilted toward each other near x-y plane imaging system 46, the guide structure has a more severe angular cutoff.

The guides preferably are dielectric, but they preferably are also absorbing to eliminate stray light. One way to accomplish this is with a glossy black dielectric coating. This coating can be applied to a number of surfaces: metal, polymer, glass, or a composite. Alternatively, the guides could be coated with a highly reflective metal layer which also only allows light with near grazing incidence to pass through. Another alternative is to use absorptive materials for the walls, for example materials used for neutral density filters, or glass or plastic with added absorptive particles (e.g., carbon particles). An absorptive semiconductor coating could also be used (amorphous silicon on glass, for example). Alternately, a silicon substate can be used. Coatings can be added as necessary. A multilayer composite layer could also be used on the substrate, for example an absorptive layer with a dielectric on top. As a final example, microstructure moth-eye or porous dielectrics layers could also be used. These lower the refractive index and therefore the reflection near grazing, which then lowers the etendue and capture angle of the guides.

In FIG. 7, the y-z plane imaging system 44 is located before the guide and focuses light into the guide thru y-z plane absorbing aperture 55. Light 10 is only collected at a small angle 40 and focused into grazing incidence waveguide core 61 at a small angle 45. This light propagates through the guide and is focused onto the image sensor 16 by x-y plane imaging system 46 and y-z plane image sensor focusing system 56. In this example, both the x-y plane imaging system 46 and y-z plane image sensor focusing system 56 are located after the guide. Color separation is performed by color separation optical system 58, as described above for FIG. 5.

This approach can form a very compact system. For example, light collected from a 100 um wide scanline 10 (i.e., extending 100 um in the z direction) and collected at approximately 0.5 degrees (collection angle 40) can be focused to the guide collection angle 45 and with a guide height 43 of 100 um. Assuming a thrice folded guide with three 100 um cores spaced by four 100 um walls, the total height could be only 700 um. Folded geometries are discussed in more detail below.

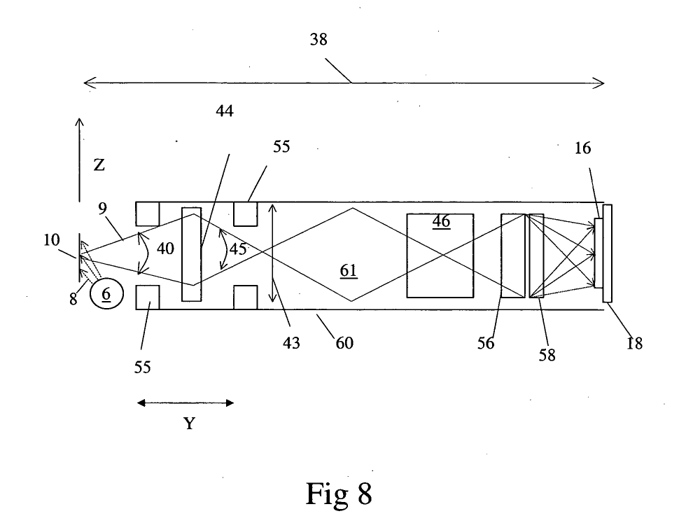

An even more compact system can be made if one or all of the external imaging elements are inserted in the guide. FIG. 8 shows a variation of the system of FIG. 7 where all the elements are placed within the guide. The y-z plane imaging system 44 is located near the front of the guide and the x-y plane imaging system 46 is located near the back of the guide. These elements may be fastened using conventional optical adhesives. In some configurations, the optics may have a roughened non planar surface at the adhesive sides adjacent the guide and use a high index optically absorbing adhesive in between the guide and the optical element to inhibit total internal reflection. Folded systems of this type as well as variations on the optical elements are discussed in further detail below.

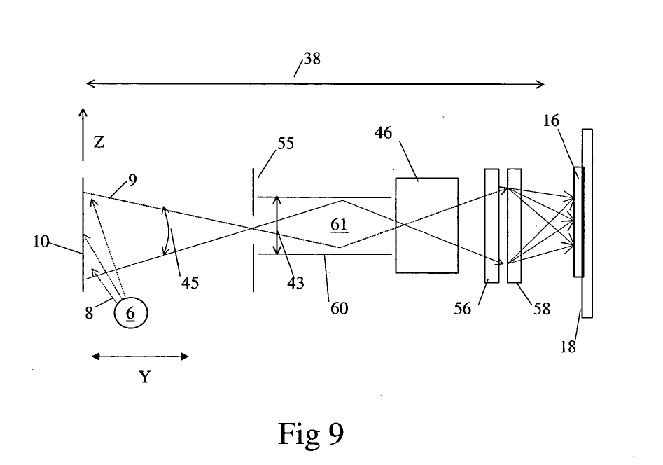

FIG. 9 is a variation of the system of FIG. 7. Here, the front imaging system 44 has been removed. There are no elements with optical power before the guide. Instead, the imaging system relies upon the very low guide collection angle 45 of the guide. This system typically will have a shallower depth of field than the other systems that use a lens. However, for many applications, this is quite acceptable given the tradeoff of lower complexity and cost. Additionally, since the guide optical response is known, the resolution of the final image can be improved via deconvolution of the overall image data. Of course, this system can also be made using fully interior optics as shown in FIG. 8, but without the front y-z plane imaging system 44.

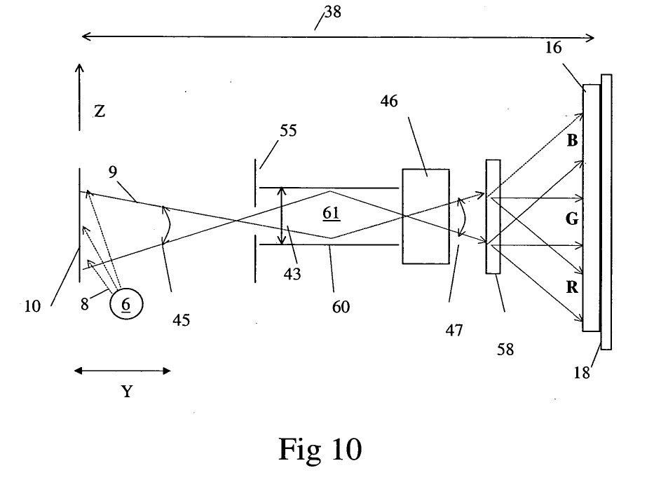

FIG. 10 is an extension of the system of FIG. 9. Here, the rear lens 56 of the system of FIG. 9 has been additionally removed and the nearly collimated beam, with a small angle 47, exiting the guides is split by color separation optical system 58 where it is incident on image sensor 16. In this case, there are no focusing optics to form a very thin line so a two-dimensional detector array preferably is used. A three line array with tall pixels can also be used. In this embodiment as well as those of FIGS. 7, 8, and 9, the color separation optical system 58 may be eliminated by creating an arrayed system similar to that used in the system of FIG. 6.

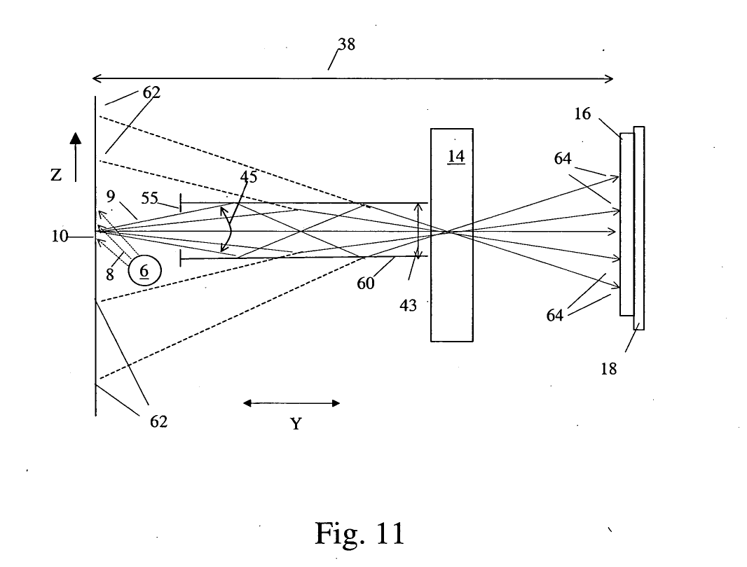

As shown in FIG. 11, a grazing incidence guide may also be used with a conventional reduction optics lens system 14. In this embodiment, the y-z plane imaging system images the same as the x-y plane imaging system. Light emanating from the scanline 10 appears to originate from multiple virtual images 62, each of which is imaged to a real image 64 at the image sensor plane. Color separation optics typically are not required. Instead, multiple lines of detectors may be used with color separation filters or a conventional area array may be used to detect the signal. For example, a red filtered line of detectors can be located at one real image 64, blue filtered detectors at another real image 64 and green filtered detectors at a third real image 64.

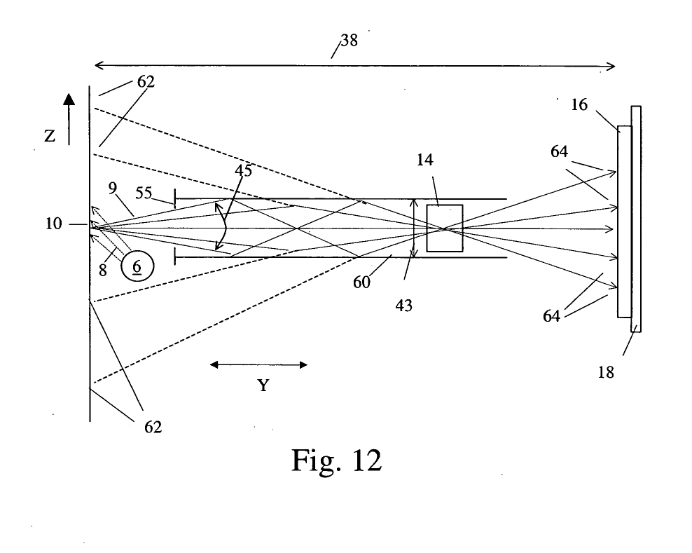

In addition, since the different rays emanating from the same point on scanline 10 represent different angular domains, information about the tilt of the paper (or other angular effects) may be obtained by comparing the image intensity of the images equidistant from and on opposite sides of the central ray. Additionally, as a document or object being scanned is moved away from the platen and becomes defocused, the images closest to the central image remain in better relative focus and can be used to recreate an accurate image. In contrast, in a conventional reduction system, all the light is collected over the full angular range and angular information typically cannot be recovered or utilized. Since only a narrow region of lens system 14 is used, a thinner lens may be placed inside the guide as shown in FIG. 12, forming a more compact optical system.

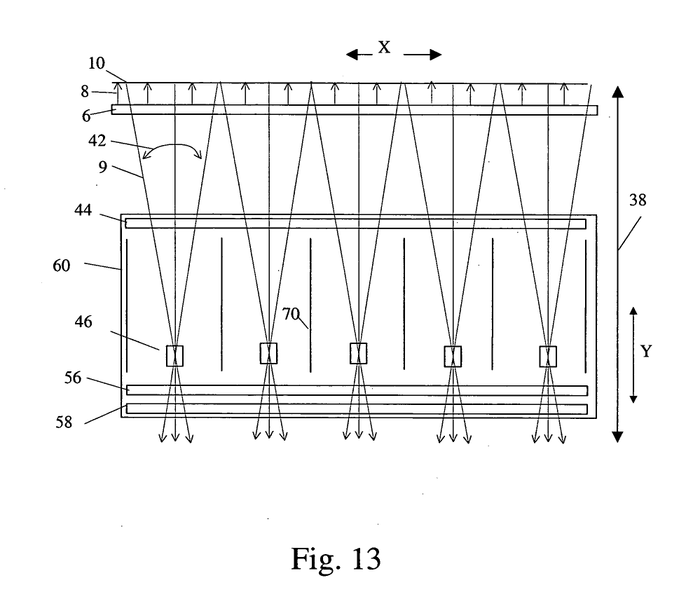

FIG. 13 shows an optical scanhead in which the basic design shown in FIG. 8 is arrayed in the x direction. The subsystems are separated by an absorbing baffle 70. Each of these subsystems is a proportionally reduced subsystem compared to that of FIG. 8. That is, the same angle 42 is subtended by the x-y imaging system 44 as with that of FIG. 8. However, since the actual field in the x direction is reduced by the number of subsystems, so the total length 38 of the system is also proportionally reduced. This concept of arraying systems in the x direction may be extended to the other embodiments shown in FIGS. 3-12.

Regardless of whether a conventional reduction system, CIS system, Cooke triplet or double Gauss lens system is used, light from the edges of the document are captured at an extreme angle. This has several drawbacks. First, the amount of light captured from the edges is decreased due to cosine effects. Second, objects at the edge have a different magnification ratio than objects in the center, which is referred to as “keystoning.” Third, at the extremes, the “in focus” zone defined by the depth of field is at an angle relative to the platen. Therefore, any variation in height of an object causes further distortion.

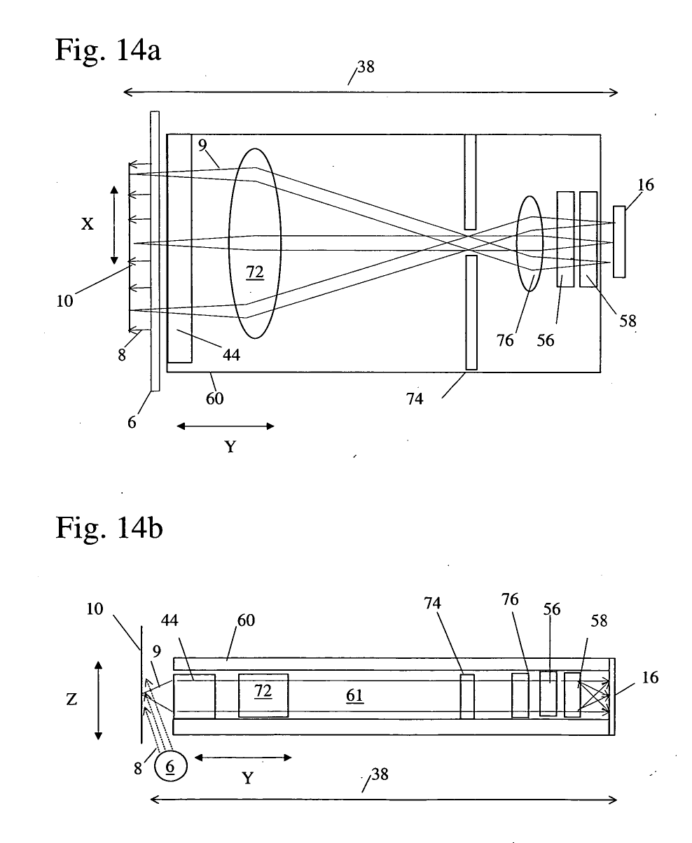

A telecentric system does not have the problems of the conventional reduction system. FIG. 14a shows a top view of an anamorphic telecentric system enclosed within a grazing incidence guide in a similar manner to the system of FIG. 8. FIG. 14b shows the side view. Front telecentric imaging system 72 and rear telecentric imaging system 76 in conjunction with x-y plane absorbing aperture 74 form a telecentric system imaging the scanline in the x-y plane. Both lenses are shown here as single lenses but may be constructed of multiple elements. As shown, this system is telecentric in both object and image space. An alternate telecentric system removes rear telecentric imaging system 76 with front telecentric imaging system 72 focusing at image sensor 16. That system is telecentric only in object space. As in a conventional telecentric system, the system “looks” perpendicular to the object under scan across the entire scanline. Compared to other three-dimensional telecentric systems, the lens systems are less bulky. The y-z plane imaging systems 44 and y-z plane image sensor focusing system 56 perform the same function as in previous embodiments. Optional color separation is shown as a transmissive element color separation optical system 58. However, previously described techniques can be used. Additionally, although this example was based on the system of FIG. 8, the other variations of internal and external elements, as discussed in FIGS. 3-12, may also be used.

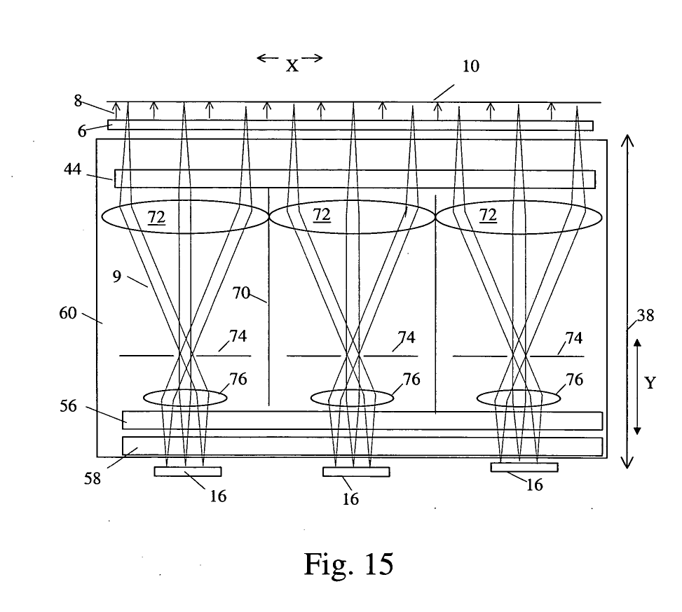

The telecentric approach can also be formed into an array of smaller telecentric subsystems. FIG. 15 shows a top view of the telecentric array. This structure is essentially the same as in FIG. 14, but replicated three times. As with the arrayed system of FIG. 13, the advantage of this system compared to that of FIG. 14 is reduced overall size.

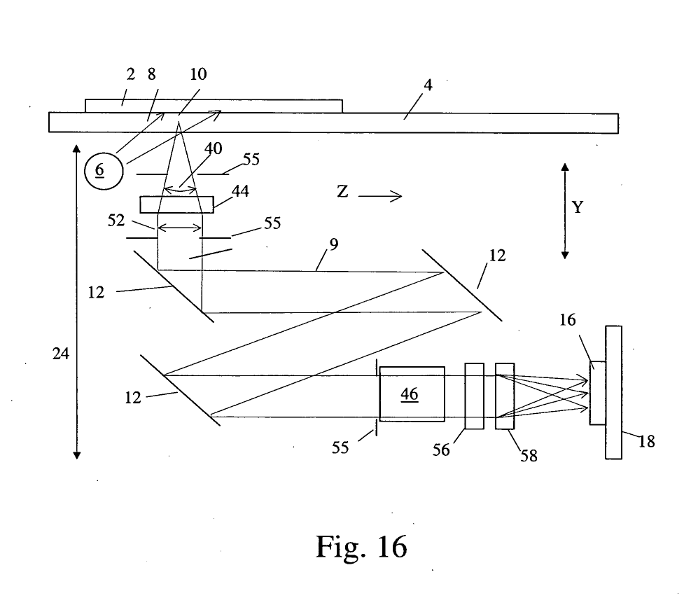

FIGS. 3-14 were all described in the context of “unfolded” systems for clarity. These systems can also be folded to reduce the size of the system. Folding can be accomplished using planar mirrors and a “diagonal” or “z” shaped folding of the optical beam. This technique works well for systems without a guide or arrayed stacking in the z direction. For example, the systems shown in FIGS. 3-5 are well suited for this type of folding. FIG. 16 shows a folded version of the collimated anamorphic system of FIG. 5, including platen and illumination system. Because of the small beam height 52 formed by this system, the optical beam may be very tightly folded. For example, a beam height 52 of approximately 0.5 mm is possible. The total overall scanhead height 24 may be less than several millimeters. This is substantially smaller than the height of common reduction optics systems (typically 1.5″ or so). As in all figures with a folded optical axis, the direction arrows y and z show these directions at the platen but it should be understood that these directions change as the optical axis is folded.

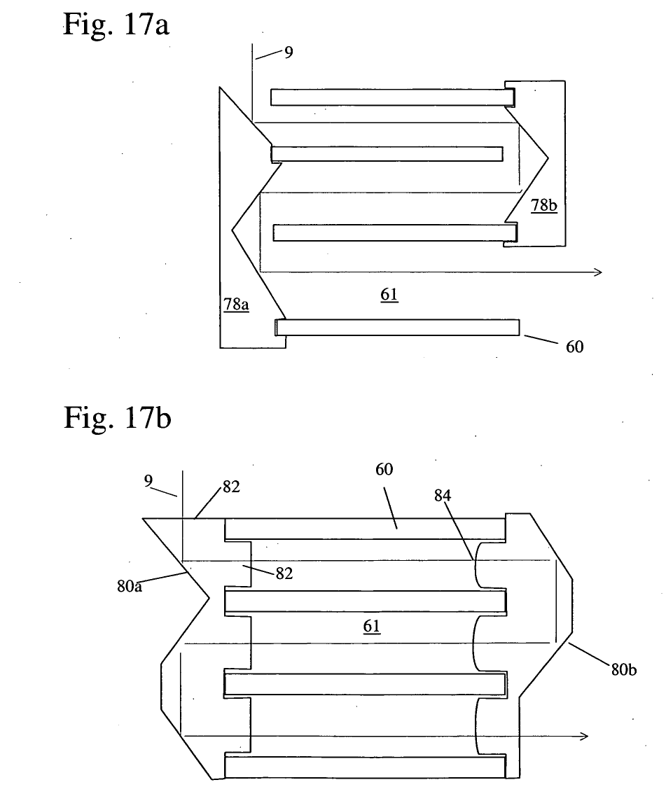

A grazing incidence system can also be folded using planar mirrors. In addition to the diagonal beam approach shown in FIG. 16, a stacked waveguide using beam turning mirrors is more compact and easier to manufacture. FIGS. 17-25 show side cross-sectional views of different examples of stacked waveguides. In FIG. 17a, the waveguide walls 60 and cores 61 form a stack of waveguides. Guide supports 78a and 78b have right angle surfaces that act as a pair of mirrors to direction the beam 9 from one waveguide to the next. The surfaces are coated to be reflective and may also use a special coating to reduce loss. In FIG. 17a, the spacing between the guides for subsequent layers is increased. This is an option to accommodate a small angular spread within the beam once the beam exits the guide before entering the next guide. The supports 78a and 78b also acts as supports for the waveguide walls 60.

The beam turning approach of FIG. 17b uses a right angle prism reflecting guide support 80a-b with antireflection coatings 82 on the faces. The right angle prism acts by total internal reflection. Lensed face 84 shows an option of using a slightly lensed surface at the entrance and exit faces. These lenses act to contain the spread of the beam upon exiting the guide. Note also, that this function is somewhat fulfilled by the refractive bending toward a normal to the face by the prism medium. Finally, lensed face 84 protrudes slightly into the guide to create more support.

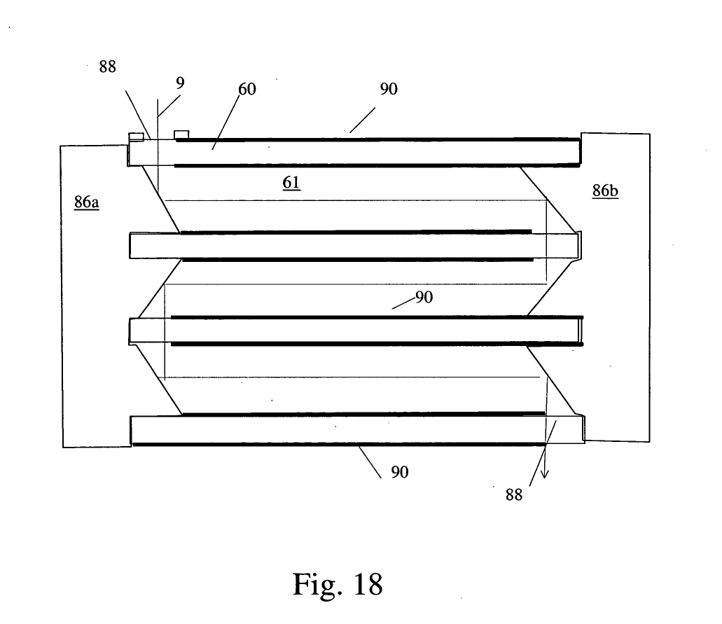

The beam turning optics shown in FIG. 17 sit with the reflective device external and adjacent the guide. FIG. 18 shows a reflective face inserted inside the guide. That is, the optical beam 9 passes through the waveguide wall material 60 as it is directed from one waveguide to the next. For example, the wall 60 could have a clear aperture or holes could be created in the walls 60 at these locations. This configuration supplies support for the guides similar to the TIR beam turning optics of FIG. 17b and will be referred to as the internal mirrored guide support 86. When the reflecting face is internal to the device then the grazing incidence waveguide wall 60 has a transparent section forming the guide aperture 88 and preferably is also coated with a glossy absorbing dielectric 90 or other reflective material as described above. Alternatively, the aperture may be formed by creating a hole in an otherwise solid grazing incidence waveguide wall 60.

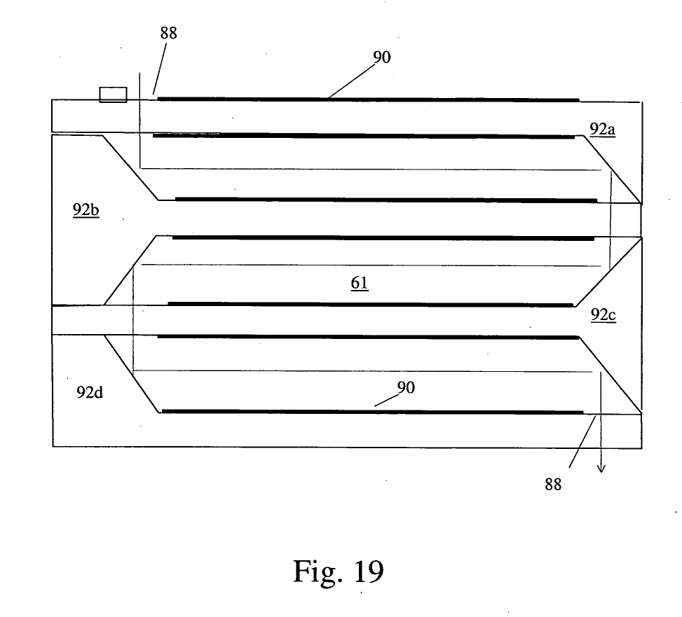

FIG. 19 shows a variation of FIG. 18. Here, the separate reflector 86 of FIG. 18 has been eliminated. Instead, the guide structure 92 is made of a transmissive dielectric such as optical grade acrylic or glass, and has been molded to form several variations where both the guide substrate and the reflecting beam turning optic are integrated. In those areas where the light reflects at a 45 degree angle, the reflective beam turning guide 92 is coated with a reflector, or a separate reflector is attached. At the waveguide walls, the substrate is coated with an absorbing (black) glossy dielectric 90 as described above. Guide apertures 88 are formed to allow light into and out of the guide structure.

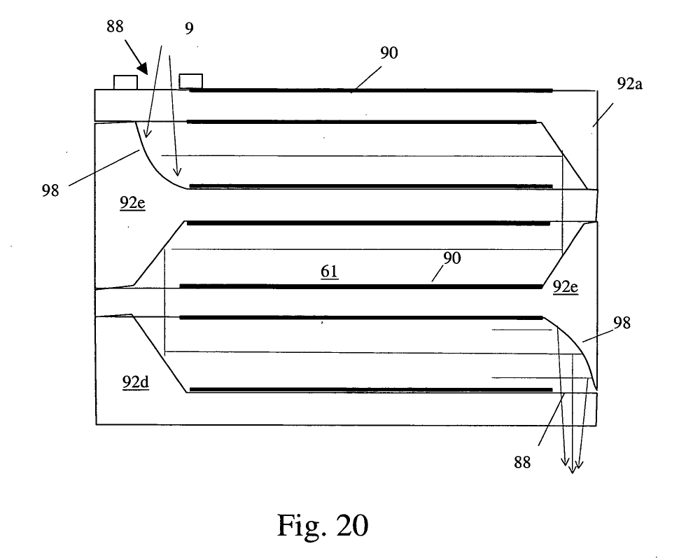

FIG. 20 is similar to the system of FIG. 19. However, instead of planar mirrors, curved reflecting faces 98 are formed at the entrance and exit reflector faces of 92e to form cylindrical mirrors. These cylindrical mirrors aid in coupling light in an out of the guides and reduce the number of elements required for input and output coupling optics.

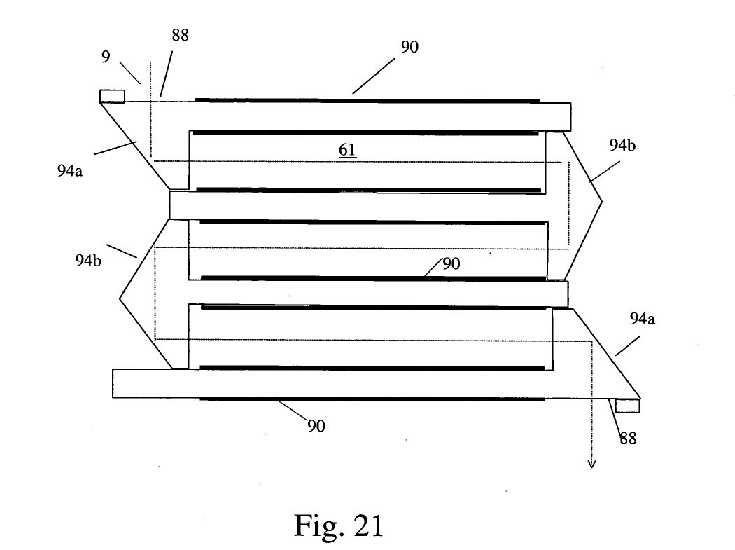

FIG. 21 is similar to the structure of FIG. 17b but instead uses total internal reflection (“TIR”) reflector integrated with the grazing incidence guide structure to form a TIR beam turning guides 94a and b. As with the stacked waveguides of FIGS. 19 and 20, the reflection is internal to the overall structure and an optically clear material is used for the TIR beam turning guides 94a-d. The glossy coating 90 and guide apertures 88 can be created as described previously.

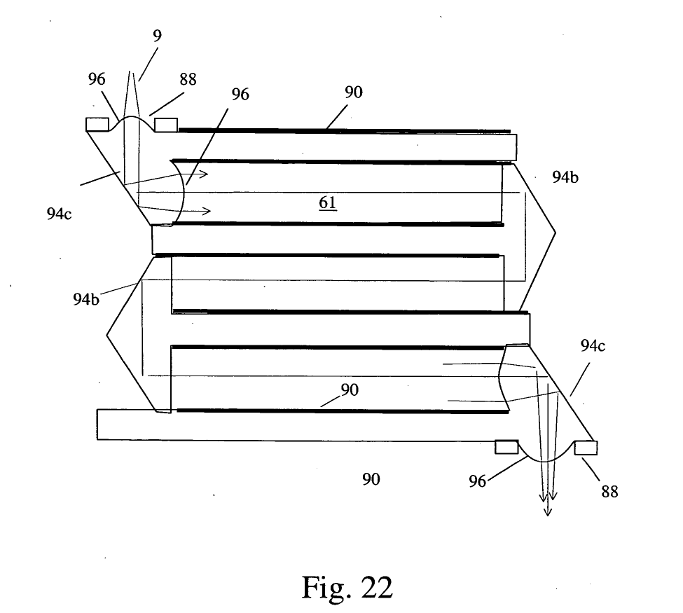

FIG. 22 shows TIR guide lenses 96 incorporated into the faces of TIR beam turning guides 94a to form 94c. As with the cylindrical reflecting faces of FIG. 20, these lenses aid in coupling light in an out of the guides and act to reduce the number of elements required for input and output coupling optics.

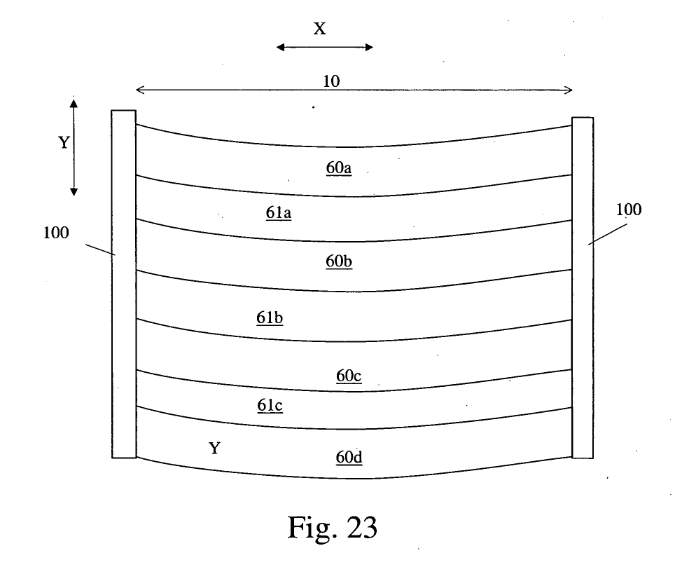

FIG. 23 is a rear cross-sectional view of a guide structure. Comparing FIGS. 17b (a side cross-sectional view) and 23, both FIG. 17b and FIG. 23 show three waveguides, as indicated by the number of waveguide cores 61. In FIG. 17b, the light enters the waveguide structure from the top, travels to the right, is reflected down to the next waveguide, travels to the left, is reflected down and then travels to the right before exiting. In FIG. 23, the light enters the waveguide structure from the top, travels along the top core 61a towards the viewer (perpendicular to the paper), is reflected down to the next waveguide (reflector not shown), travels along the middle core 61b away from the viewer, is reflected down to the next waveguide, and travels along the bottom core 61c towards the viewer.

If the guides are only supported at either end of the scanline 10 by a fixed end support 100, the guides may sag as shown in FIG. 23. This sag can cause distortion and deflection of the optical beams. If the guides are thick enough, the distortion may be insignificant. However, for a 100 um thick glass plate 75 mm wide and supported at either end of a 216 mm length (8.5″), the sag is approximately 2 mm. In many of the designs shown in FIGS. 17-22, the beam turning optics provide additional support to the guides. However, if there is no adequate interlayer or edge support, the guide must be increased either in thickness, elastic modulus, or be attached to a layer that is thicker or has a higher modulus.

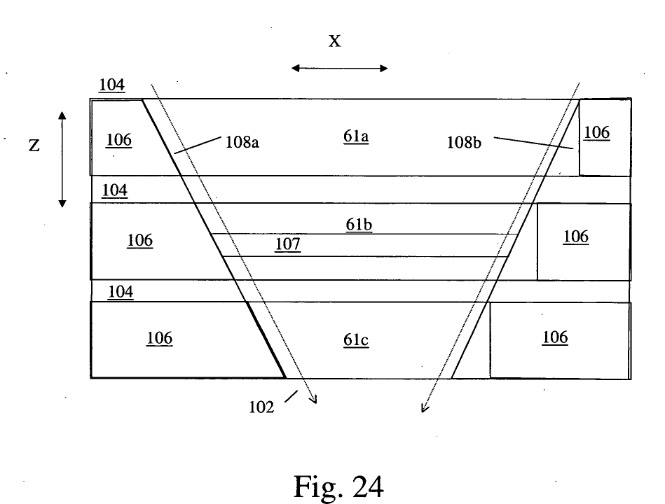

An alternate approach is to create interlayer supports. FIG. 24 shows an unfolded diagram of the guides and light path for a system using a converging optical path such as the system of FIG. 8. The cores 61a-61c are the cores for three stacked waveguides. Physically, these waveguides are stacked on top of each other, as described previously. In FIG. 24, the stack has been unfolded to show the optical path in the x-z plane. Areas 104 represent the optical paths in the beam turning optics. Light reflected from the scanline 10 is imaged onto the image sensor (not shown in FIG. 24). Rays 102 represent the outermost rays for this imaging function. There is no optical activity outside the area defined by rays 102, so the area outside these ray paths is not needed optically.

Therefore, this area can be filled with an interlayer guide support structure when the guide is folded. This interlayer guide support 106 can be made of light absorbing glass or other optically absorbing material. Additionally, honeycombed or foamed material can be used as long as the inner edges meet the optical criteria described below. The inner edges of the support can either be tapered as shown by the interlayer guide support edge 108a or perpendicular to the long edge of the guide as shown by interlayer guide support edge 108b. This edge preferably should not reflect specularly, but should act as an absorber and/or diffuser. Other segmented supports, including unconnected segmented interlayer supports can also be used.

In addition, supports can also be located internal to the waveguides if they are transparent. FIG. 24 shows an example support 107 which in this example is a transparent dielectric bar. The size, shape and location of the supports can be adjusted as needed, and these supports can also be designed to introduce optical correction, if desired. In one approach, the supports can be formed lithographically. Alternately, they can be separate components that are added to the structure. They preferably are AR coated.

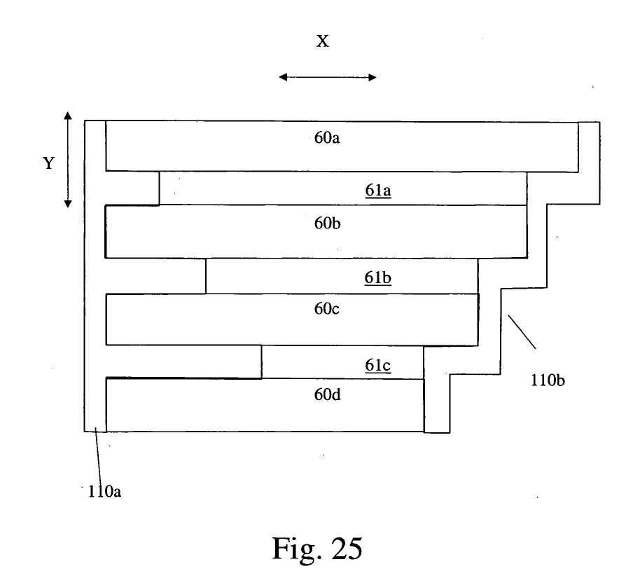

FIG. 25 shows two examples of supports using the concepts of FIG. 24. The left half of FIG. 25 shows a support structure 110a that uses long grazing incidence waveguide walls 60. One advantage of this approach is that the waveguide walls 60 can all be made the same length, reducing the number of different parts. The right half of FIG. 25 shows an example where each successive guide layer 60 is shortened in order to be lighter and use less material.

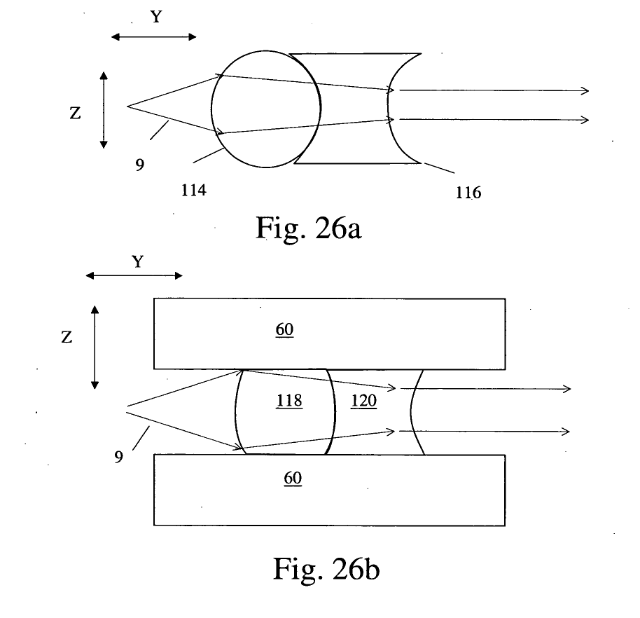

FIGS. 26-29 show examples of different types of lenses that can be used in the y-z plane imaging system. As stated above, an achromatic cylindrical doublet, shown in cross section in FIG. 26a, is well suited for the y-z plane imaging system. The positive cylinder lens 114 has lower dispersion but higher optical power than negative cylindrical lens 116. The doublet can be made with glass, plastic, or a combination of the two. In general, glass elements have low expansion coefficients and should perform over temperature and humidity variations typically encountered, although polymers can be used if proper athermalization techniques are used. When the cylindrical doublet is placed inside the guide, only a thin slice of the lens is required. For example, FIG. 26b shows the same lens of FIG. 26a but with the height truncated. Lens 118 is the truncated positive cylinder lens with high dispersion and lens 120 is the truncated negative cylinder lens with low power and high dispersion. Hybrid diffractive-refractive optics using a combination of a conventional refractive lens and binary optic can also be used but designing a doublet which is both achromatic and athermal is difficult. For hybrid systems, a triplet may be used as described in Herzig, Hans Peter, Micro-Optics: Elements, Systems, and Applications, Taylor & Francis, 1997, ISBN 0-7484-0481-3, the teachings of which are incorporated by reference herein.

Cylindrical singlets can also be used, depending on the application. In many applications, there will be a low numerical aperture and small beam height (due to the proximity of the lens to the object). The resulting aberrations are small, so that singlets can be used. Singlets can be economically manufactured by molded polymers.

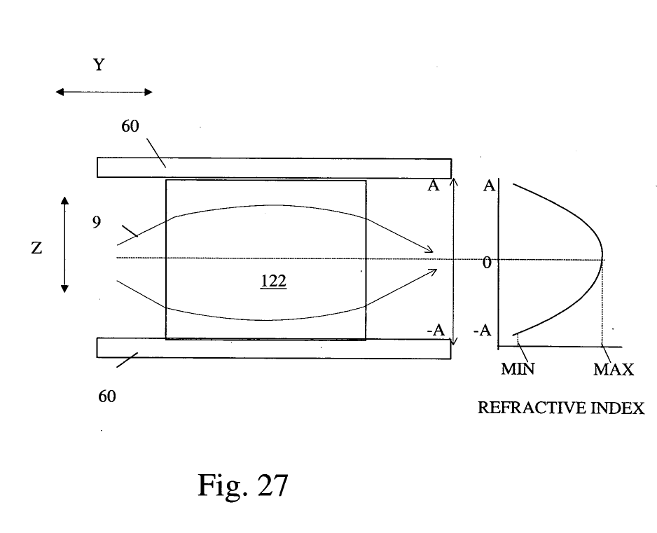

In addition to conventional and binary optical devices, planar GRIN lenses can also be used. A planar GRIN lens 122 in FIG. 27 has a graded refractive index only along the vertical axis. For example, reflected light 9 from the scanline entering this lens will be focused. As is well known with GRIN lenses, depending upon where the lens is cut, it can be focusing, collimating or diverging. This thin structure could easily fit within the hollow cavity of the grazing incidence waveguide 61 and be used as part of the y-z imaging systems.

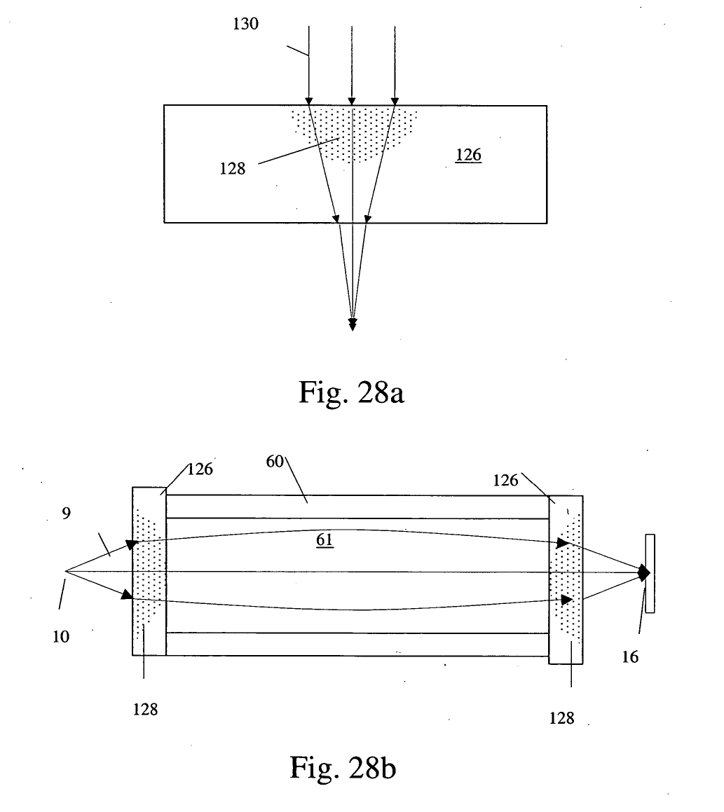

In addition to the planar GRIN lens used for input and output coupling described above, another type of graded index planar lens may be used. FIG. 28a shows the basic diffused lens. Object 126 is the glass diffusion substrate and object 128 is the diffused ions creating a refractive index change. Parallel light rays 130 strike the lens and are focused as shown. This element can be applied to the open core grazing incidence waveguide 61 as shown in FIG. 28b, although typically this device would be used in conjunction with other lenses. Reflected light rays 9 originating at scanline 10 are coupled into the grazing incidence waveguide 61. These rays propagate down the air core and are focused to image sensor 16 by the rear-mounted lens.

Rays coming from the ends of the scanline typically will hit the y-z plane imaging system at different angles than rays coming from the center of the scanline. For example, if a cylindrical singlet is used, rays from the ends of the scanline will hit the singlet at an angle rather than perpendicularly, as is the case with rays from the center of the scanline. At low numerical apertures and beam heights, the resulting aberrations typically will be small. However, the y-z plane imaging system can be designed to compensate for this effect. For example, variable conics can be used, or lenses and/or detectors can be curved.

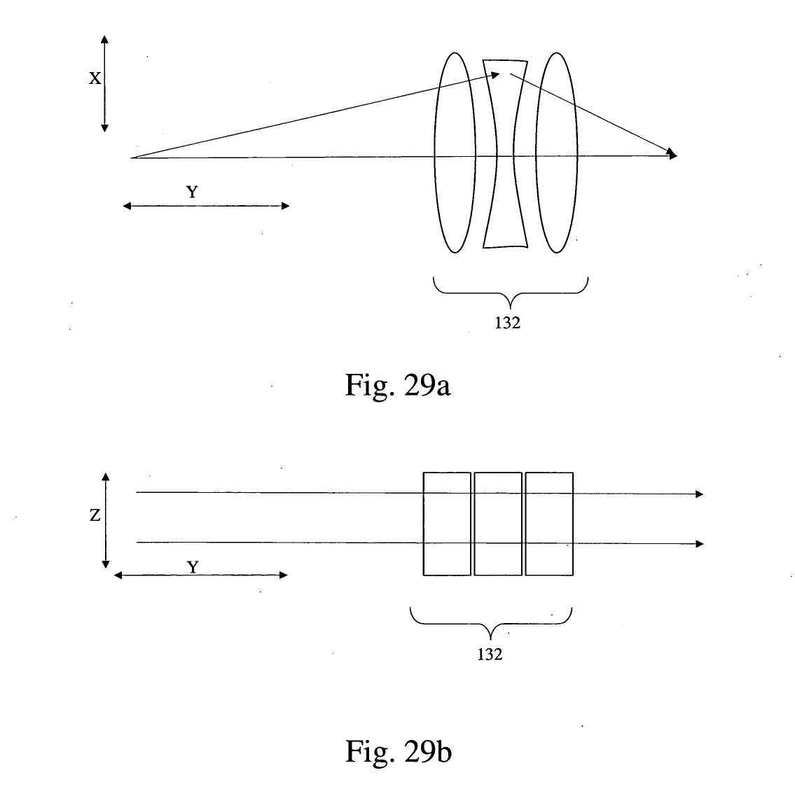

In the x direction, along the scanline, imaging of the high field angle is best served by triplets, split triplets such as Tessars and Heliars, and double Gauss systems. However, in the anamorphic systems shown above, this typically uses a cylindrical planar version of those lenses. FIG. 29a shows the curvatures along one plane for a triplet version of such an x-y planar lens 132. Light traveling along this plane is imaged in a conventional way. However, when the x-y planar lens system 132 is rotated axially, light traveling in the perpendicular plane (i.e., in the y-z plane) sees a series of varying thickness slabs. Manufacture of such lens elements can be by conventional methods used to produce cylindrical lenses. Additionally, due to the thin planar nature of the lenses, laser cutting, as well as ring cutting and diamond wire cutting, may be used to cut the lens elements from a polished glass flat.

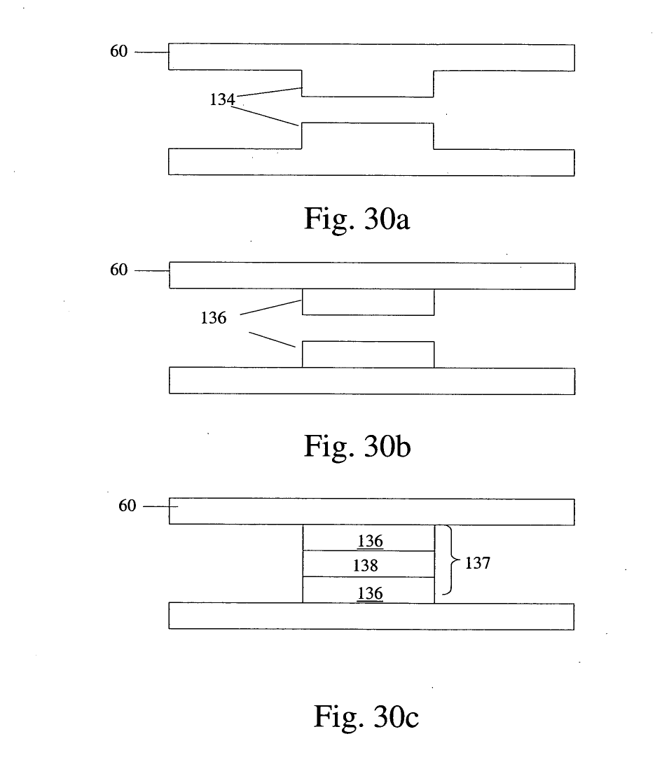

Referring again to FIG. 8, an internal y-z plane absorbing aperture 55 is desirable to eliminate stray rays. This aperture may be formed in several ways. First, as shown in FIG. 30a, the grazing incidence waveguide wall 60 may be formed such that it has a long absorbing pedestal 134 emerging from the surface. Second, as shown in FIG. 30b, the aperture may consist of absorbing plates 136 glued to grazing incidence waveguide wall 60. Third, as shown in FIG. 30c, there may be a separate component absorbing aperture system 137 made from a layering of a clear glass or plastic aperture substrate 138 with two absorbing aperture laminate 136 laminated above and below the glass layer.

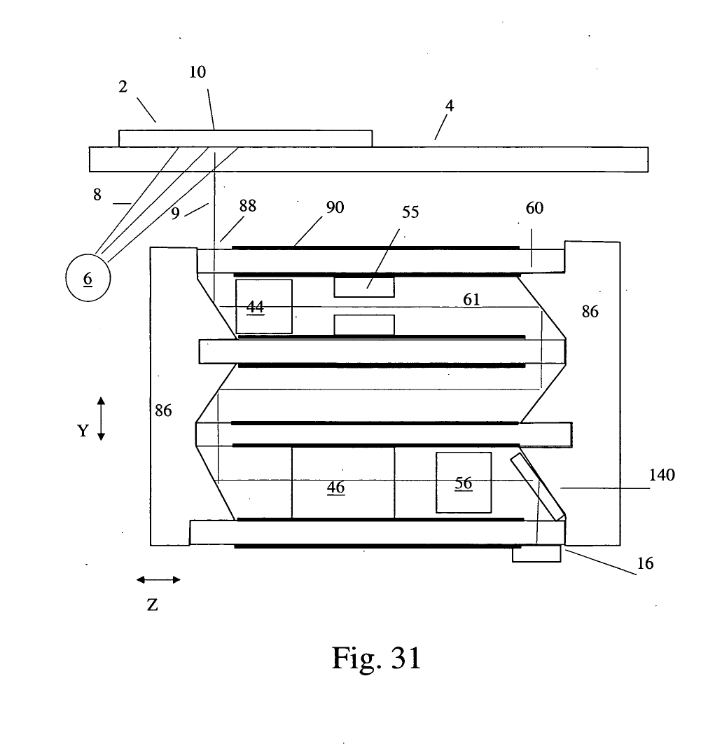

FIGS. 31-36 are examples of folded optical scanheads based on the grazing incidence and anamorphic principles described above. As with the examples given above, these systems are also merely examples. Other combinations and variations of the grazing incidence and anamorphic concepts will be apparent. In the following examples, one difference between the various grazing incidence systems (and stacked array optics) is whether the optical elements are placed external to or within the grazing incidence waveguides. The folded height of the systems below are limited primarily by the height of the stacked guides. That stacked height can be less than 1 mm with a guide wall thickness and spacing of 100 um. Thus, these systems can be made with extremely low height compared to conventional reduction systems while having similar depth-of-field performance.

FIG. 31 shows a folded version of the grazing incidence system of FIG. 8 where the optical elements are internal to the guides. Similar to FIG. 1, there are the white light illumination system 6, the transparent platen 4, and the document under scan 2. Incident light 8 reflects from the document at scanline 10 and travels through aperture 88. The light reflects off the reflecting beam turning optic is captured by planar y-z plane imaging system 44, which captures the imaged light from scanline 10 and focuses it through planar y-z plane absorbing aperture 55. After exiting absorbing aperture 55, the light proceeds down the grazing incidence guide 61 with absorbing glossy dielectric 90. After transiting through subsequent folds, the light is imaged by the planar x-y imaging system 46. The light strikes y-z plane image sensor focusing system 56 where it is focused to image sensor 16. Preceding this, reflecting color separation optic 140 acts to separate the focused beam into three lines of red, green or blue light. This reflecting color separation optic can either be a reflecting diffractive optics, such as a Dammann grating, or other reflective color separation system.

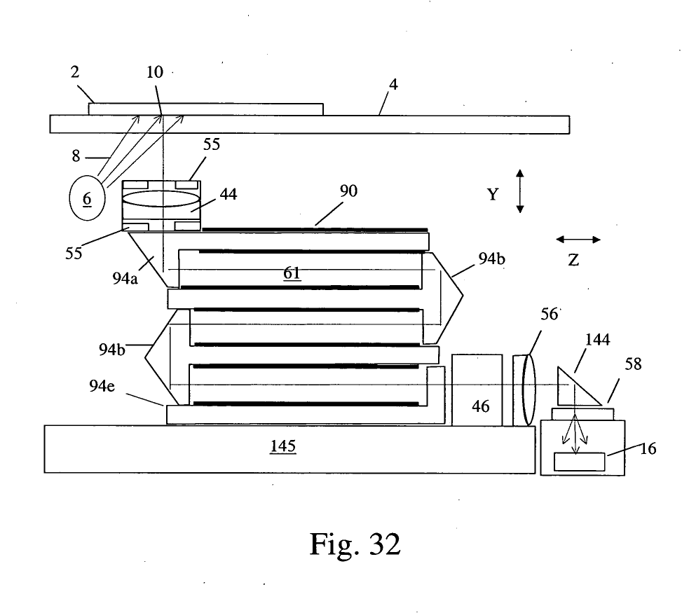

FIG. 32 shows a folded version of the grazing incidence system of FIG. 7. This is effectively the same as the internal system of FIG. 31, except the optical elements are placed outside the guide. This system uses TIR beam folding, simply as a contrast to FIG. 31. This system also uses a beam turning prism 144, which could also be replaced by a flat mirror. In this example, the y-z plane imaging system 44 is integrated with y-z plane absorbing apertures 55. Also, system base 145 mechanically supports the system.

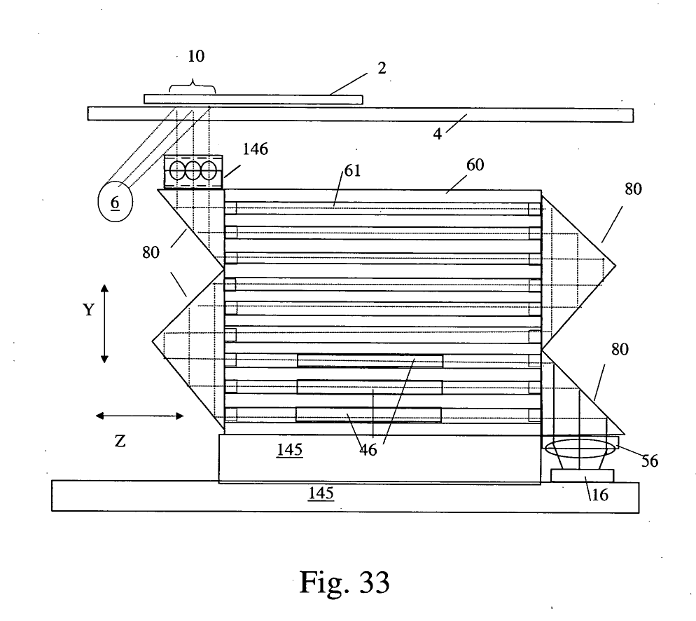

FIG. 33 shows a folded version of a system combining the basic system of FIG. 7 with the arrayed aspect of FIG. 6. Here, there are three adjacent y-z imaging systems 44 integrated with three y-z plane absorbing apertures 55. Together they are collectively referred to as a compound y-z plane imaging system 146. TIR type beam folding optic 80 reflects the optical beam although other reflectors could also be substituted. The individual beams from each of the three guides focuses on a separate line of area on the detector array. Each of these lines or areas will have a color band-pass filter over it in the same way as the reduction system of FIG. 1.

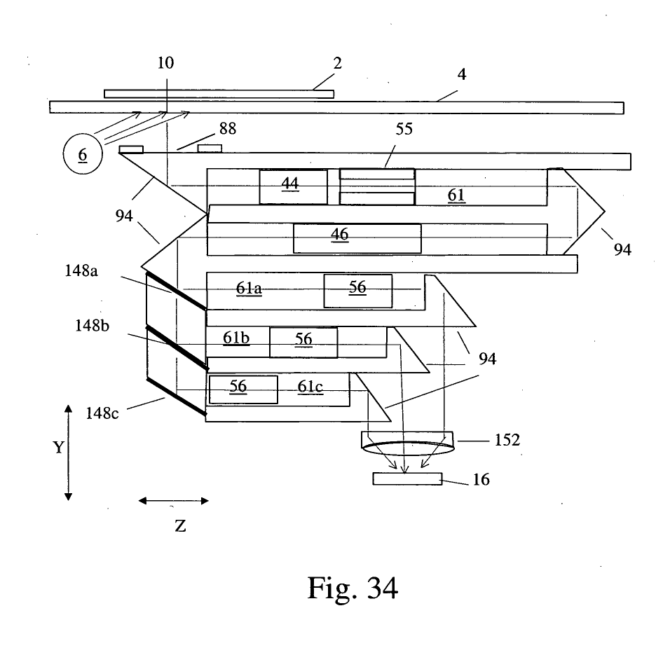

FIG. 34 shows a system uses a combination of the last three systems. Some of the optics are internal and some of the optics are external. The beam turning optics are primarily TIR-based. This system introduces a hybrid color separation scheme partly borrowed from the stacked optics concept. The y-z plane imaging system 44 and the x-y plane imaging system 46 act to focus the light for all colors and then each of the wavelengths bands red, green and blue are split off into separate waveguides by color separation filters 148a, b, and c coated or glued or otherwise optically coupled to the faces shown. Blue light incident on 148a is reflected down guide core 61a. Green and Red light pass through. Red light is then reflected off 148b and travels down guide core 61b. Finally, green light is reflected off 148c and reflected down guide core 61c. Each of these colors is then focused by y-z plane image sensor focusing system 56 in each of the separate cores. Each of these colors is then reflected off the TIR reflector at the end of each guide and is directed by 152 to the image sensor 16. Image sensor 16 can be either a two-dimensional array or a three line array. Color filters placed over those detectors help reject any stray colors not rejected by the filters 148.

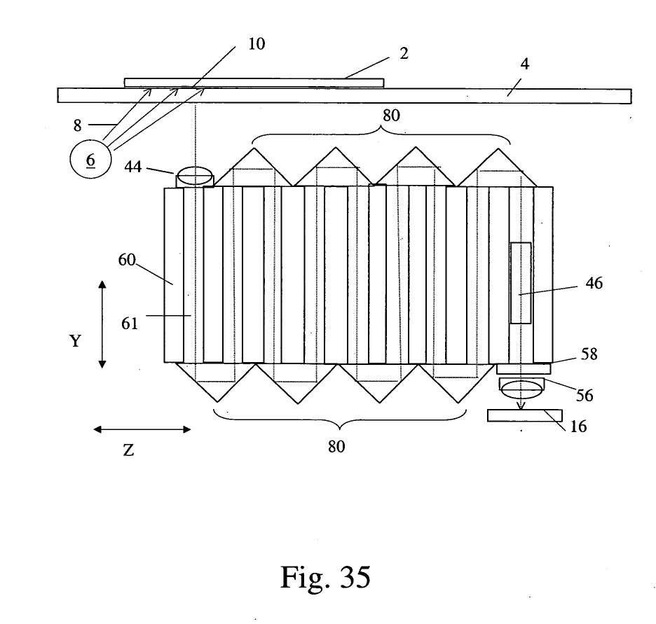

The guides need not always be oriented horizontally. FIG. 35 shows a system using previously described elements but with vertically oriented guides. This system eliminates any potential for sag as discussed above.

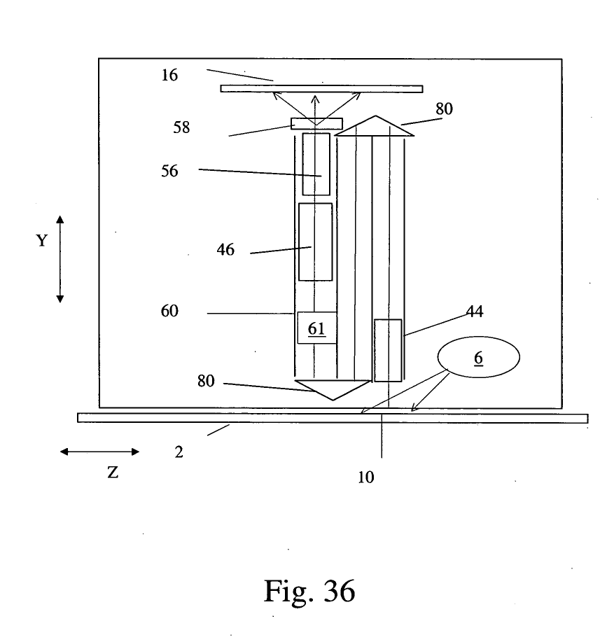

FIG. 36 shows an example of a handheld system using a variation of the vertically oriented guide system of FIG. 35. The high aspect ratio of the y extent compared to the z extent shown in FIG. 36 is suitable to the general configuration encountered in handheld devices such as cellular phone and personal digital assistants. Reduction systems have been applied to handheld devices as described by U.S. Pat. No. 6,184,515 by Boln, but the optical system is inherently larger than the thin systems described above and in FIG. 36.

As a final example, detector arrays of different resolutions can also be accommodated. In one approach, pixel binning is used to implement different resolutions. Alternately, twice the number of detector arrays (for two different resolutions) can be used and the scanline can be imaged to a line that is wide enough to cover both arrays. The approach shown in FIGS. 6 and/or 33 could also be used, with each detector array being a different resolution rather than recovering a different color component.

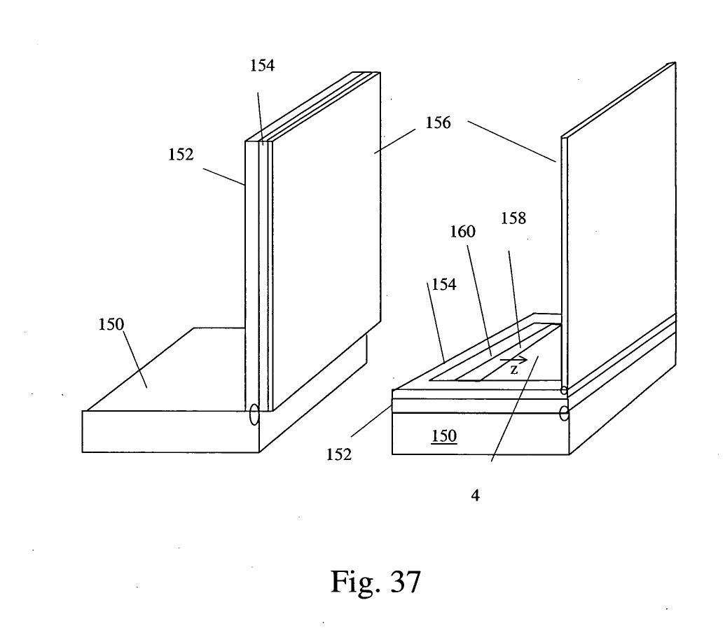

The thinness of the stacked grazing incidence systems not only creates a significant improvement in conventional flat bed scanner and multifunction scanner-printer systems, but also enables a completely new platform—a high depth of field flatbed scanner in the lid or base of a laptop computer (or any other similarly sized lid or base). As shown in FIG. 37, the scanner is mounted on a laptop computer defined by the laptop base 150 and the laptop lid 152. When the laptop lid 152 is closed, the scanner lid 156 can be opened to reveal the transparent platen 4 and the laptop scanhead 158 mounted under the platen. The electronics for control of the scanner can be included with the laptop electronics. Operation is essentially the same as a conventional flatbed scanner.

Even using a 500 um thick guide layer and height and an embedded lens, similar to that shown in FIG. 33, the scanhead guide structure is roughly 1.5 mm thick. With an approximately 1.5 mm thick printed circuit board base and a 1 mm coplanar cold cathode fluorescent lamp, the scanhead height is approximately 3 mm. Given a 2 mm spacing under the platen and a 3 mm thick transparent platen, the total added thickness of the scanner base 154, the scan base can be around 8 mm or approximately 1/3 inch. Including an approximately 1.5 mm ( 1/16″) lid 156 the total is approximately 9.5 mm or less than 0.4″, or about as thick as the lid on a conventional flatbed scanner. Alternately, the scanner base can be built into the lid 156.

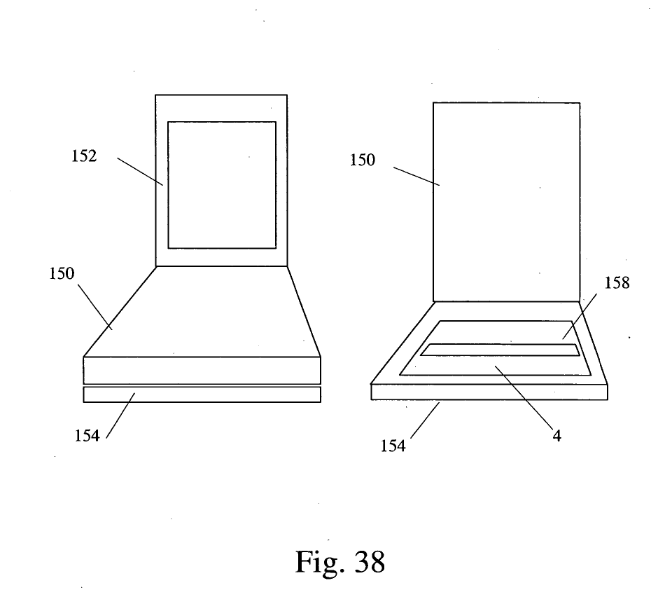

If desired, the thin flatbed scanner can be mounted underneath the scanner as shown in FIG. 38. In this case, only the scanner base 154 of FIG. 37 is needed since the laptop base 150 replaces the scanner lid 156 of FIG. 37. The laptop base 150 is flipped up to reveal the platen 4 and scanhead 158 in the base 154. The document is placed on the platen and the laptop base is lowered to close the scanner. Alternately, the scanner base can be built into the bottom of the laptop base 150.

In one design, the flatbed scanners in FIGS. 37 and 38 use the basic scanhead design shown in FIG. 33 with the following modifications. First, the system is not arrayed, as is shown in FIG. 33. Rather than simultaneously imaging three parallel scanlines, one each for red, green and blue, a single scanline is imaged and a Dammann system is used for color separation. The waveguides preferably are plastic or glass with an absorbing coating. The input y-z lens 44 (referring to FIG. 7), 146 is a molded polymer singlet. The x-z lens 46 is a flat cylinder lens triplet. The y-z image sensor focusing system is a molded lens 56 with a transmissive Dammann and CCD stack 16. A pedestal is used to mount the waveguide stack over the image sensor, which is supported on a PC board.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

1. An optical scanhead for scanning a scanline of an object, where the object lies in an x-z plane and the scanline extends along an x direction, the scanhead comprising:
a y-z plane imaging system for imaging the scanline in a y-z plane;
an x-y plane imaging system for imaging the scanline in an x-y plane;
wherein the y-z plane imaging system images differently than the x-y plane imaging system.

2. The scanhead of claim 1 wherein no optical element in the optical scanhead has an optical power both in the x-y plane and in the y-z plane.

3. The scanhead of claim 2 wherein all optical elements in the optical scanhead that have optical power in the x-y plane are cylindrical elements.

4. The scanhead of claim 2 wherein all optical elements in the optical scanhead that have optical power in the y-z plane are cylindrical components.

5. The scanhead of claim 1 wherein the y-z plane imaging system includes an achromatic doublet.

6. The scanhead of claim 1 wherein the x-y plane imaging system includes a lens element selected from the group consisting of a triplet, a split triplet and a double Gauss.

7. The scanhead of claim 1 wherein the y-z plane imaging system comprises:
a first imaging system for imaging the scanline in the y-z plane to an intermediate image; and
an image sensor focusing system for relaying the intermediate image in the y-z plane to an image sensor.

8. The scanhead of claim 7 wherein the x-y plane imaging system comprises:
a second imaging system located between the first imaging system and the image sensor focusing system, for imaging the scanline in the x-y plane to the image sensor.

9. The scanhead of claim 1 wherein the y-z plane imaging system comprises:
an imaging system for imaging the scanline in the y-z plane to an intermediate image; and
at least one relay for relaying the intermediate image in the y-z plane to an image sensor.

10. The scanhead of claim 1 wherein the y-z plane imaging system comprises:
a first imaging system for imaging the scanline in the y-z plane to near infinity.

11. The scanhead of claim 10 wherein the y-z plane imaging system further comprises:
a color separation optical system for separating the scanline into colors.

12. The scanhead of claim 10 further comprising:
a second imaging system for imaging a second scanline in the y-z plane to near infinity,
wherein the second scanline and the second imaging system are displaced along the z direction relative to the first scanline and the first imaging system.

13. The scanhead of claim 1 wherein the optical axis is folded.

14. The scanhead of claim 13 wherein the optical axis is folded into a “z” shape.

15. The scanhead of claim 1 wherein the y-z plane imaging system comprises:
a grazing incidence waveguide.

16. The scanhead of claim 1 wherein the optical scanhead comprises:
a plurality of subsystems arrayed in the x direction, each subsystem for imaging a portion of the scanline, each subsystem comprising:
a y-z plane imaging system for imaging the portion of the scanline in the y-z plane;
an x-y plane imaging system for imaging the portion of the scanline in the x-y plane;
wherein the y-z plane imaging system images differently than the x-y plane imaging system.

17. The scanhead of claim 1 wherein the x-y plane imaging system comprises:
a telecentric imaging system.

18. The scanhead of claim 1 wherein the y-z plane imaging system has a maximum beam height of not more than 0.5 mm.

19. The scanhead of claim 1 wherein the scanline has a length of approximately 8.5″.

20. The scanhead of claim 19 wherein the scanhead has a physical height of not more than 5 mm.

21. An optical scanhead for scanning a scanline of an object, where the object lies in an x-z plane and the scanline extends along an x direction, the scanhead comprising:
an x-y plane imaging system for imaging the scanline in an x-y plane; and
a y-z plane imaging system for imaging the scanline in a y-z plane, the y-z plane imaging system including a grazing incidence waveguide.

22. The scanhead of claim 21 wherein the y-z plane imaging system comprises:
an imaging system located before the grazing incidence waveguide.

23. The scanhead of claim 21 wherein the y-z plane imaging system comprises:
an imaging system located within the grazing incidence waveguide and near a front of the grazing incidence waveguide.

24. The scanhead of claim 21 wherein no optical elements in the optical scanhead that have optical power are located before the grazing incidence waveguide.

25. The scanhead of claim 21 wherein the y-z plane imaging system comprises:
an aperture located internal to the grazing incidence waveguide.

26. The scanhead of claim 21 wherein the x-y plane imaging system comprises:
an imaging system located after the grazing incidence waveguide.

27. The scanhead of claim 21 wherein the x-y plane imaging system comprises:
an imaging system located within the grazing incidence waveguide and near a back of the grazing incidence waveguide.

28. The scanhead of claim 21 wherein the y-z plane imaging system images the same as the x-y plane imaging system.

29. The scanhead of claim 21 wherein at least one optical element in the optical scanhead that has optical power is located internal to the grazing incidence waveguide.

30. The scanhead of claim 29 wherein all optical elements in the optical scanhead that have optical power are located internal to the grazing incidence waveguide.

31. The scanhead of claim 21 wherein all optical elements in the optical scanhead that have optical power are located external to the grazing incidence waveguide.

32. The scanhead of claim 21 wherein the optical scanhead comprises:
a plurality of subsystems arrayed in the x direction, each subsystem for imaging a portion of the scanline, each subsystem comprising:
an x-y plane imaging system for imaging the portion of the scanline in the x-y plane; and
a y-z plane imaging system for imaging the portion of the scanline in the y-z plane, the y-z plane imaging system including a grazing incidence waveguide.

33. The scanhead of claim 21 wherein the x-y plane imaging system comprises:
a telecentric imaging system.

34. The scanhead of claim 21 wherein the grazing incidence waveguide has a core with a height of not more than 100 um.

35. An optical scanhead for scanning a scanline of an object, where the object lies in an x-z plane and the scanline extends along an x direction, the scanhead comprising:
an x-y plane imaging system for imaging the scanline in an x-y plane; and
a y-z plane imaging system for imaging the scanline in a y-z plane, the y-z plane imaging system comprising a stacked grazing incidence waveguide comprising:
a stack of grazing incidence waveguides; and
beam turning elements for directing light from one waveguide in the stack to a next waveguide in the stack.

36. The scanhead of claim 35 wherein the beam turning elements are external to the waveguides.

37. The scanhead of claim 35 wherein the beam turning elements are internal to the waveguides.

38. The scanhead of claim 35 wherein at least one beam turning element has optical power.

39. The scanhead of claim 35 wherein the beam turning elements are integrated with walls of the waveguides.

40. The scanhead of claim 35 wherein the beam turning elements are integrated with cores of the waveguides.

41. The scanhead of claim 35 wherein the stacked waveguide is constructed from a plurality of similarly shaped guide structures.

42. The scanhead of claim 35 wherein either an input or an output to the stacked waveguide has optical power.

43. The scanhead of claim 35 wherein downstream waveguides have narrower unsupported sections as measured along the x direction.

44. The scanhead of claim 35 wherein the stacked waveguide has a height of not more than 700 um.

45. An optical scanhead for scanning a scanline of an object, where the object lies in an x-z plane and the scanline extends along an x direction, the scanhead comprising:
a stacked grazing incidence waveguide wherein the waveguides are stacked along a y direction;
a y-z plane lens system located before or towards a front of the stacked grazing incidence waveguide, the y-z plane lens system for imaging the scanline in a y-z plane; and
an x-y plane lens system located after or towards a back of the stacked grazing incidence waveguide, the x-y plane lens system for imaging the scanline in an x-z plane.

46. The scanhead of claim 45 further comprising:
an image sensor located after the x-y plane lens system.

47. The scanhead of claim 46 wherein the image sensor comprises:
two linear arrays of different resolutions.

48. The scanhead of claim 45 wherein the y-z plane lens system consists of a cylindrical singlet.

49. The scanhead of claim 45 wherein the stacked grazing incidence waveguide includes at least three stacked waveguides and has a height of not more than 1 mm.

50. A device comprising an integrated combination of a laptop computer and a flatbed scanner, wherein the flatbed scanner includes an anamorphic optical scanhead.

51. The device of claim 50 wherein the anamorphic optical scanhead includes a grazing incidence waveguide.

52. The device of claim 50 wherein the flatbed scanner is integrated with a lid of the laptop computer.

53. The device of claim 50 wherein the flatbed scanner is integrated with a base of the laptop computer.
